(19) United States
(12) Patent Application Publication
(10) Pub. No.: US 2005/0138604 A1
(43) Pub. Date: Jun. 23, 2005

(54) Browser configuration

(76) Inventor: Peter Harrison, Baden-Ruetihof (CH)

Correspondence Address: SWIDLER BERLIN LLP, 3000 K STREET, NW, BOX IP, WASHINGTON, DC, 20007, US

(21) Appl. No.: 10/739,337

(22) Filed: Dec. 19, 2003

(51) Int. Cl. G06F 9/44; G06F 15/16

(52) U.S. Cl. 717/121; 717/115; 709/203

(57) ABSTRACT

A method for proxy auto-configuration of browser software is described. The browser software is running on a first computer connected to a network and the method comprises: a. receiving, at a second computer, address information for the first computer; b. retrieving appropriate configuration data from a store of configuration data connected to the second computer in accordance with the received address information; and c. transmitting the retrieved configuration data to the client in order to configure the browser software.

This invention relates to the configuration of browser software to use an appropriate proxy server.

Data, for example document files, stored on a web server connected to the Internet or on an Intranet are commonly accessed by entering into a browser the uniform resource locator (URL) that points to the data. The browser then retrieves the data and displays it on the client computer on which it is running. The URL identifies the location of the data and the protocol that should be used to retrieve them.

It is known for browser software running on a client computer connected to a network to access data pointed to by a URL via a proxy server. The URL is forwarded to the proxy server which then retrieves the data pointed to by the URL either from its own cache, if the data have been previously accessed, or from the server storing the data, and then forwards these to the client computer.

Typically, browser software is configured to use a proxy server by providing the browser software with the network address of the proxy server. More recently, browsers have made use of so-called proxy auto-configuration (PAC) scripts that instruct the browser how it should deal with different types of URL. For example, the PAC script may direct the browser to access data located on an Intranet directly whilst data located on the Internet are accessed via the proxy server.

There is a problem with these configuration techniques when they are used on larger networks which have more than one proxy server. Specifically, a very large, complex PAC script is required to configure the browser. This PAC script must be interpreted by the browser for each URL that is entered into the browser and this slows down the speed of operation of the browser and makes it difficult for network administration staff to maintain the PAC script.

In accordance with one aspect of the present invention, there is provided a method for proxy auto-configuration of browser software running on a first computer connected to a network, the method comprising:
a. receiving, at a second computer, address information for the first computer;
b. retrieving appropriate configuration data from a store of configuration data connected to the second computer in accordance with the received address information; and
c. transmitting the retrieved configuration data to the client in order to configure the browser software.

Hence, the invention overcomes the aforementioned problem by providing a method by which browser software may be centrally configured to use the most appropriate proxy server without requiring the browser to interpret a large configuration script.

Typically, the configuration scripts are proxy auto-configuration (PAC) scripts.

Normally, the second computer is configured as a web server.

In accordance with a second aspect of the present invention, a computer network system comprises at least one client running browser software, and a web server, wherein the web server is adapted to perform a method according to the first aspect of the invention.

In a third aspect, a computer program comprises computer program code means adapted to perform a method according to the first aspect of the invention when said program is run on a computer.

In a fourth aspect of the invention, a computer program product comprises program code means installed on a computer readable medium for performing a method according to the first aspect of the invention when said program is run on a computer.

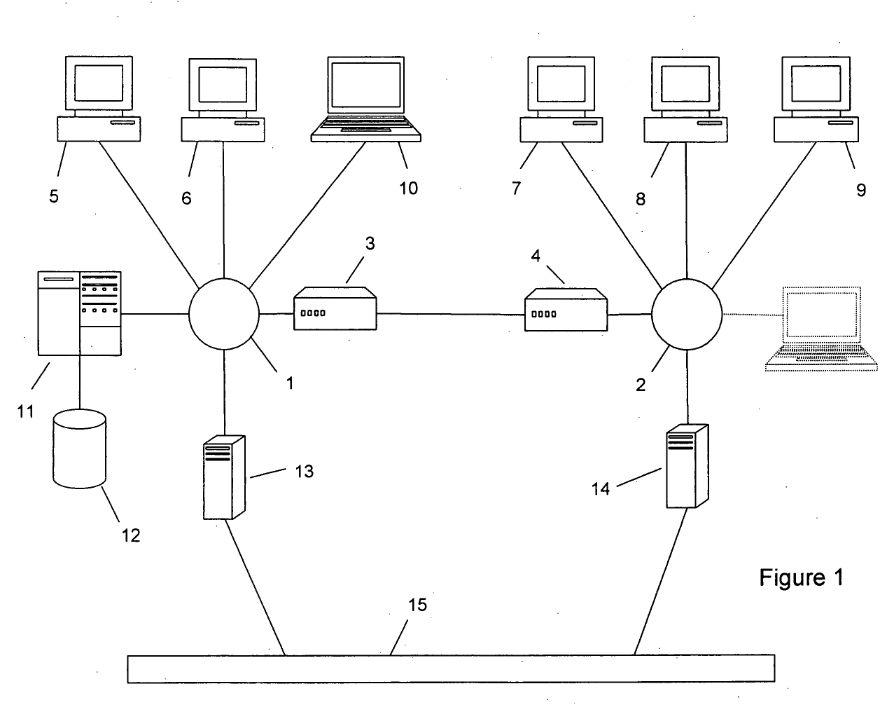

An embodiment of the invention will now be described with reference to the accompanying drawing, FIG. 1, which shows schematically a computer network.

In FIG. 1, there are shown two network hubs 1 and 2, each of which is located in a separate building. For example, hub 1 may be located in an office building where sales, administration, accounts and other office based departments of a company are located and hub 2 may be located in the same company's factory or warehouse. Each hub 1 and 2 forms a LAN for the respective building and these are connected by routers 3 and 4 to form a WAN.

A plurality of workstations 5,6,7,8 and 9 are connected to hubs 1 and 2 as shown in FIG. 1 and in the case of hub 1, a laptop computer 10 is also connected.

A web server 11 is also connected to hub 1 and this may be used for serving hypertext markup language (HTML) pages on request to any of the workstations 5 to 9 or laptop 10 connected to the network. A store 12 is connected to web server 11 and this stores a set of configuration scripts as will be described later.

Each of the hubs 1 and 2 is connected via a respective proxy server 13,14 to the Internet 15.

In a typical network setup, each of the workstations 5 to 9 and the laptop 10 may be configured to access the respective proxy server 13,14 for the hub 1,2 to which they are connected by configuring the browser software to refer all URL requests to that respective proxy server 13,14. A problem exists with this technique in that if, for example, the laptop 10 is temporarily disconnected from hub 1 and reconnected to hub 2 (as shown in dashed lines) then all URLs will be routed over the WAN via routers 3,4 and onwards to proxy server 13 since the browser software on laptop 10 is configured to forward all URL requests to proxy server 13. The result of this is that network traffic is not routed in the most efficient manner under all circumstances. Furthermore if the network address of either proxy server 13 or 14 changes then it is necessary to change the configuration of the browser software on each workstation 5 to 9 and laptop 10 that is configured to use that proxy server.

It is possible to overcome the first problem using a PAC script but for a large network such a script must be very large in order to account for all available proxy servers and the browser software must interpret this script for each URL request. This has a deleterious effect on the browser performance.

In the arrangement shown in FIG. 1, web server 11 has access to a plurality of PAC scripts that are located in the store 12. When browser software starts on any of the workstations 5 to 9 or laptop 10, it requests a PAC file from the web server 11. Software running on web server 11 intercepts this request and extracts the network address, for example an Internet Protocol (IP) address, from the network packets forming the request sent by the relevant workstation 5 to 9 or laptop 10. By applying a subnet mask to this IP address, the software running on web server 11 can determine where the requesting browser software is located. In particular, it determines whether it is connected to hub 1 or hub 2 and retrieves an appropriate PAC file from store 12 and transmits this PAC file to the workstation 5 to 9 or laptop 10. The software may be provided as a module or modules for the web server software, e.g. Apache.

The store 12 may be, for example, a hard disk or other storage means. In this case, the store 12 is the internal memory of web server 11, each PAC file being retrieved into the internal memory from a hard disk connected to web server 11 when the software initialises.

For example, if workstation 5 requests a PAC script from web server 11 then the software running on web server 11 will determine from the IP address of workstation 5 that it forms part of the subnet formed around hub 1 and serve to it a PAC script that instructs it to access URLs on the Intranet directly and to access any URL on the Internet via proxy server 13. A similar PAC file would be served to any of workstations 7 to 9 via routers 3 and 4 to configure them to use proxy server 14 for Internet access.

In this way, if laptop 10 is connected to hub 2 (as shown in dashed lines on FIG. 1) and its IP address is changed from the value it had when connected to hub 1, for example if its IP address is dynamically allocated using dynamic host configuration protocol (DHCP) or a similar protocol, then web server 11 can detect that it is connected to hub 2 and serve the appropriate PAC file to configure the browser software on laptop 10 to use proxy server 14 rather than proxy server 13 for Internet access.

The PAC files are standard in nature and may configure the browser software in various ways. For example, the PAC file served to workstations 5,6 may configure them such that if proxy server 13 is not functioning they will instead use proxy server 14 via routers 3 and 4 and the WAN to access the Internet 15. Other possibilities include the provision of multiple proxy servers connected to each of hubs 1 and 2 for load sharing purposes. In this scenario, all URLs pointing to a server in the “.com” domain may be forwarded to a first proxy server whilst all other URLs will be forwarded to a second proxy server. Alternatively, all hypertext transfer protocol (HTTP) URLs may be forwarded to a first proxy server whilst all other URLs, for example file transfer protocol (FTP) URLs, may be forwarded to a second proxy server. The man skilled in the art will be aware of the large variety of different possibilities of configuration that are available using PAC files.

In this way, the invention has provided a centrally maintainable configuration mechanism for browser software that ensures that the most appropriate proxy server is used depending on available network resources to ensure efficient network operation.

It is important to note that while the present invention has been described in a context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media actually used to carry out distribution. Examples of computer readable media include recordable-type media such as floppy disks, a hard disk drive, RAM and CD-ROMs as well as transmission-type media such as digital and analogue communications links.

1. A method for proxy auto-configuration of browser software running on a first computer connected to a network, the method comprising:
a. receiving, at a second computer, address information for the first computer;
b. retrieving appropriate configuration data from a store of configuration data connected to the second computer in accordance with the received address information; and
c. transmitting the retrieved configuration data to the client in order to configure the browser software.

2. A method according to claim 1, wherein the configuration scripts are proxy auto-configuration (PAC) scripts.

3. A method according to claim 1, wherein the second computer is configured as a web server.

4. A computer network system comprising at least one client running browser software, and a web server, wherein the web server is adapted to perform a method according to claim 1.

5. A computer program comprising computer program code means adapted to perform the method of claim 1 when said program is run on a computer.

6. A computer program product comprising program code means stored on a computer readable medium for performing the method of claim 1 when said program is run on a computer.
